(19) United States
(12) Patent Application Publication
(10) Pub. No.: US 2024/0298370 A1
(43) Pub. Date: Sep. 5, 2024

(54) METHODS FOR UPLINK TRANSMISSIONS IN MULTI CONNECTIVITY

(71) Applicant: InterDigital Patent Holdings, Inc., Wilmington, DE (US)

(72) Inventors: Martino Freda, Laval (CA); Oumer Teyeb, Montreal (CA)

(73) Assignee: InterDigital Patent Holdings, Inc., Wilmington, DE (US)

(21) Appl. No.: 18/574,781

(22) PCT Filed: Aug. 3, 2022
(86) PCT No.: PCT/US2022/039285

§ 371 Date: Dec. 28, 2023

Related U.S. Application Data
(60) Provisional application No. 63/228,896, filed on Aug. 3, 2021.

(51) Int. Cl. H04W 76/15; H04W 40/12; H04W 40/22; H04W 76/20

(52) U.S. Cl. CPC H04W 76/15; H04W 40/12; H04W 40/22; H04W 76/20

(57) ABSTRACT

A WTRU may perform RLM/RLF on a set of related cell groups. select a SCG on which to report a MCG failure. perform activation procedures by triggering UL transmissions, determine which SCG it can transmit data on with a single UL split threshold, and which SCG it can transmit data on with multiple UL split threshold. and/or determine the split bearer threshold to use when multiple SCGs are configured. A WTRU may receive configuration information regarding SCGs associated with each bearer of multiple bearers. and a RSRP threshold associated with each bearer. A WTRU may determine data associated with a bearer is eligible for transmission based on an UL split bearer threshold, and select a set of SCGs for transmission based on SCG RSRP values and bearer RSRP thresholds. The set of SCGs may comprise one or more SCGs.

### CROSS-REFERENCE TO RELATED APPLICATIONS

This application claims the benefit of U.S. Provisional Patent Application No. 63/228,896, filed Aug. 3, 2021, the disclosure of which is incorporated herein by reference in its entirety.

### BACKGROUND

A wireless transmit/receive unit (WTRU), also referred to user equipment (UE), may be configured to utilize resources provided by two different nodes connected via a non-ideal backhaul, wherein the nodes may provide access using the same or different radio access technologies (RATs). One node may act as a master node (MN) controlling the resources associated with one or more cells called a master cell group (MCG) and a secondary node (SN), and the other node may act as a SN. The MN and SN may be connected via a network interface and at least the MN may be connected to the core network. In the case of dual connectivity, a WTRU may be configured with two medium access control (MAC) entities; one MAC entity for the MCG and the other MAC entity for the SCG. The WTRU may be configured to receive and process a radio resource control (RRC) reconfiguration message via the MCG, wherein the reconfiguration may result in a change, addition, modification to, and/or release of a SCG.

### SUMMARY

A WTRU may be configured to determine the number of configured secondary cell groups (SCGs) to be activated based on the amount of data available for split bearers that allow an activation. The WTRU also may be configured to determine the SCGs to be used for a specific split bearer based on an activation state of the SCG, a maximum configured SCG for the bearer, a channel condition, such as a measured reference signal received power (RSRP), for example, frequency range, or the like, or any appropriate combination thereof.

A WTRU may be configured with a set of related cell groups. A WTRU may also be configured to perform radio link monitoring/radio link failure (RLM/RLF) on a set of related cell groups. A WTRU also may be configured to select a SCG on which to report a MCG failure. A WTRU may be configured to perform new activation procedures by triggering uplink (UL) transmissions. A WTRU also may be configured with rules to determine which SCG it can transmit data on with a single UL split threshold. A WTRU also may be configured with rules to determine which SCG it can transmit data on with multiple UL split threshold. A WTRU also may be configured to determine the split bearer threshold to use when multiple SCGs are configured.

In an example embodiment, a WTRU may comprise memory and a processor configured to receive configuration information regarding at least one bearer. The configuration information may comprise, for each bearer, an indication of at least one secondary cell group (SCG) associated therewith. The configuration information may comprise a reference signal received power (RSRP) threshold associated with each bearer of the at least one bearer. The WTRU further may be configured to determine that first data associated with a first bearer of the at least one bearer is eligible for transmission. The determination that the first data is eligible for transmission may be based on an uplink (UL) split bearer threshold associated with the first bearer. The WTRU also may be configured to determine a set of SCGs associated with the first bearer for transmitting the first data. The set of SCGs may comprise one or more SCGs of the at least one SCG associated with the first bearer. The determination of the set of SCGs for transmitting the first data may be based a comparison of a channel condition associated with each SCG and the channel condition associated with the first bearer. For example, the determination of the set of SCGs for transmitting the first data may be based on a RSRP value of each SCG of the set of SCGs being greater than or equal to the RSRP threshold associated with the first bearer.

In an example embodiment, a method performed by a WTRU may comprise receiving configuration information regarding at least one bearer. The configuration information may comprise, for each bearer, an indication of at least one secondary cell group (SCG) associated therewith. The configuration information may comprise a reference signal received power (RSRP) threshold associated with each bearer of the at least one bearer. The method further may determining that first data associated with a first bearer of the at least one bearer is eligible for transmission. The determination that the first data is eligible for transmission may be based on an uplink (UL) split bearer threshold associated with the first bearer. The method also may comprise determining a set of SCGs associated with the first bearer for transmitting the first data. The set of SCGs may comprise one or more SCGs of the at least one SCG associated with the first bearer. The determination of the set of SCGs for transmitting the first data may be based a comparison of a channel condition associated with each SCG and the channel condition associated with the first bearer. For example, the determination of the set of SCGs for transmitting the first data may be based on a RSRP value of each SCG of the set of SCGs being greater than or equal to the RSRP threshold associated with the first bearer.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an exemplary high-level measurement mode;

FIG. 3 is a diagram illustrating an exemplary conditional handover configuration and execution;

FIG. 4 is a diagram illustrating an exemplary split-bear transmission according to an embodiment; and

FIG. 5 is a diagram illustrating an exemplary deactivated secondary cell group (SCG) according to an embodiment.

FIG. F 6 is another diagram illustrating an exemplary deactivated SCG according to an embodiment.

FIG. 7 is a diagram illustrating an exemplary activated SCG according to an embodiment.

FIG. 8 is a flow diagram of an example process for operating with split bearers.

### DETAILED DESCRIPTION

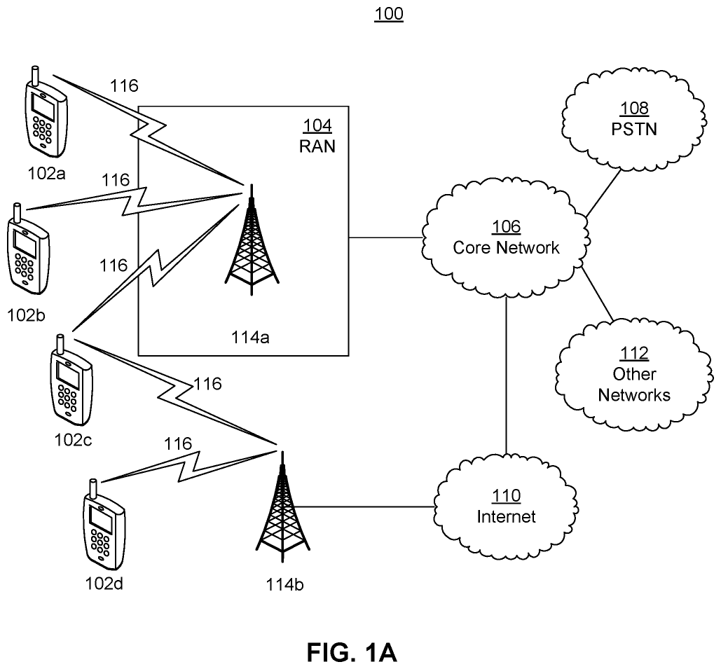

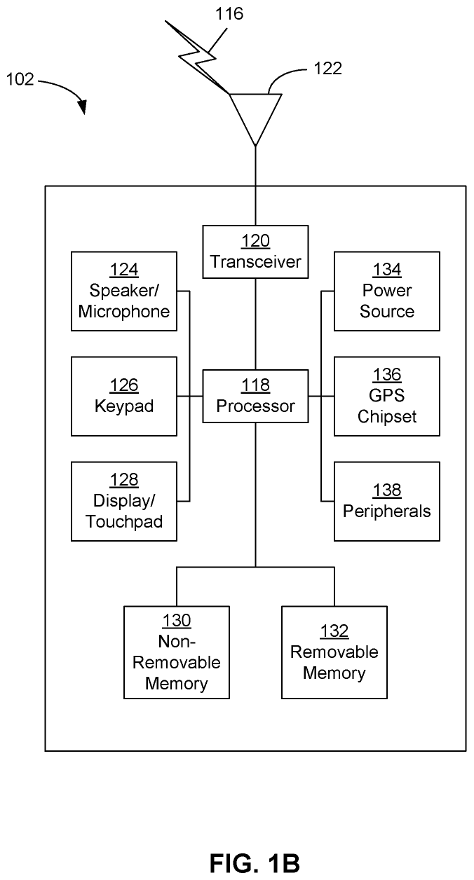

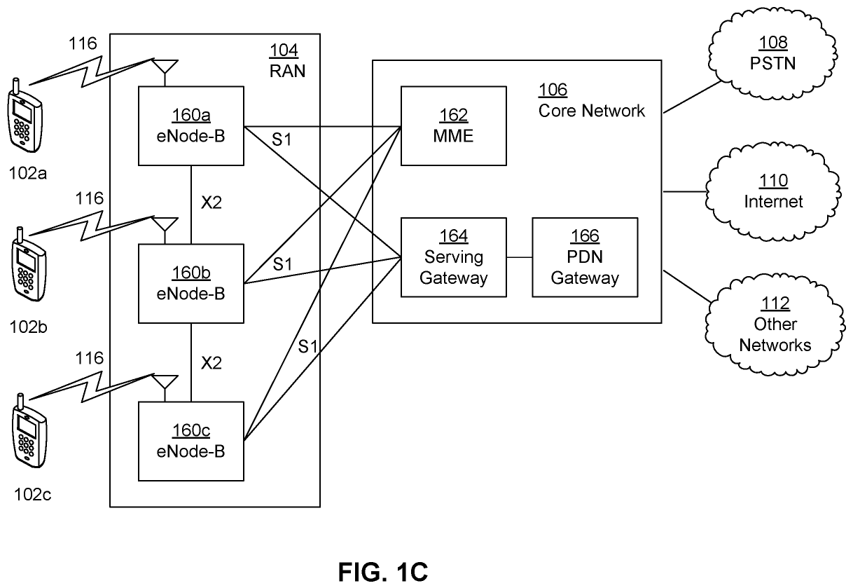

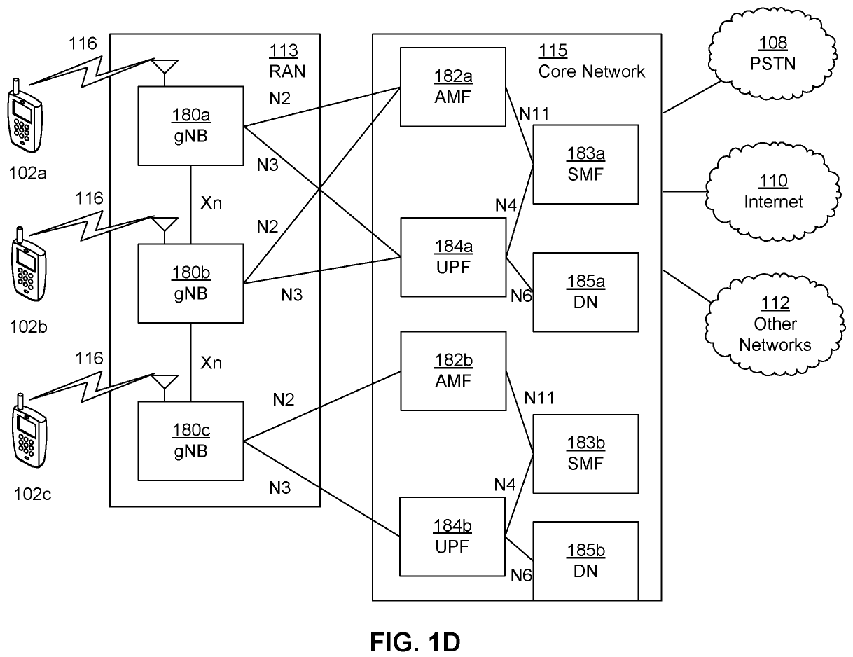

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access , which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114bmay not be required to access the Internet 110 via the CN 106.

The RAN 104 may be in communication with the CN 106, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180cmay each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102cin a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations and acronyms may be referred to herein.
Δf Sub-carrier spacing
ACK Acknowledgement
AS: Access Stratum
BLER Block Error Rate
BRS Beam Reference Signal
BTI Basic TI (in integer multiple of one or more symbol duration)
BWP Bandwidth Part
CB Contention-Based (e.g. access, channel, resource)
CE: Control Element
CHO Conditional Handover
COMP Coordinated Multi-Point transmission/reception
CP Cyclic Prefix
CP-OFDM
Conventional OFDM (relying on cyclic prefix)
CQI Channel Quality Indicator
CN Core Network (e.g. LTE packet core)
CPA Conditional PSCell Addition
CPAC Conditional PSCell Addition/Change
CPC Conditional PSCell Change
CRC Cyclic Redundancy Check
CSG Closed Subscriber Group
CSI Channel State Information
CU Central Unit
D2D Device to Device transmissions (e.g. LTE Sidelink)
DC: Dual Connectivity
DCI Downlink Control Information
DL Downlink
DM-RS Demodulation Reference Signal
DRB Data Radio Bearer
DU Distributed Unit
EPC Evolved Packet Core
E-UTRA Evolved Universal Mobile Telecommunications System Terrestrial Radio Access
FBMC Filtered Band Multi-Carrier
FBMC/OQAM A FBMC technique using Offset Quadrature Amplitude Modulation
FDD Frequency Division Duplexing
FDM Frequency Division Multiplexing
gNB: Next Generation Node B
HO: Handover
HOF: Handover Failure
ICC Industrial Control and Communications
ICIC Inter-Cell Interference Cancellation
IP Internet Protocol
IS In Synchronization
L1 Layer 1
L3 Layer 3
LAA License Assisted Access
LBT Listen-Before-Talk
LCH Logical Channel
LCP Logical Channel Prioritization
LLC Low Latency Communications
LTE Long Term Evolution e.g. from 3GPP LTE R8 and up
MAC Medium Access Control
NACK Negative ACK
MC MultiCarrier
MCG Master Cell Group
MCS Modulation and Coding Scheme
MIB Master Information Block
MIMO Multiple Input Multiple Output
MR: Multi-Radio
MTC Machine-Type Communications
NAS Non-Access Stratum
NR New Radio
OFDM Orthogonal Frequency-Division Multiplexing
Out-Of-Band (emissions)
OOB
OOS Out Of Synchronization
PDCCH: Physical Downlink Control Channel
PDCP: Packet Data Convergence Protocol
Pcmax Total available WTRU power in a given TI
PCell Primary cell of Master Cell Group
PHY Physical Layer
PRACH Physical Random Access Channel
PDU Protocol Data Unit
PER Packet Error Rate
PLMN Public Land Mobile Network
PLR Packet Loss Rate
PSCell Primary cell of a Secondary cell group
PSS Primary Synchronization Signal
QoS Quality of Service (from the physical layer perspective)
RAB Radio Access Bearer
RAN Radio Access Network
RAN PA Radio Access Network Paging Area
RACH Random Access Channel (or procedure)
RAR Random Access Response
RAT Radio Access Technology
RCU Radio access network Central Unit
RF Radio Front end
RLF Radio Link Failure
RLM Radio Link Monitoring
RNTI Radio Network Identifier
RRC Radio Resource Control
RRM Radio Resource Management
RS Reference Signal
RSRP Reference Signal Received Power
RSRQ Reference Signal Received Quality
RTT Round-Trip Time
SCell: Secondary Cell
SCG Secondary Cell Group
SR: Scheduling Request
SCMA Single Carrier Multiple Access
SCS Subcarrier Spacing
SDU Service Data Unit
SIM System Information Block
SINR Signal to Interference and Noise Ratio
SN Secondary Node
SOM
Spectrum Operation Mode
SpCell Primary cell of a master or secondary cell group, also referred to as a special cell.
S-RLF
Sidelink Radio Link Failure
SRS: Sounding Reference Signal
SS Synchronization Signal
SSB Single Side Band
SSS Secondary Synchronization Signal
SRB Signaling Radio Bearer
SWG Switching Gap (in a self-contained subframe)
TB Transport Block
TBS Transport Block Size
TDD Time-Division Duplexing
TDM Time-Division Multiplexing
TI Time Interval (in integer multiple of one or more BTI)
Transmission Time Interval (in integer multiple of one or more TI)
TTI
TRP Transmission/Reception Point
TRPG Transmission/Reception Point Group
TRx Transceiver
UFMC Universal Filtered Multicarrier
UF-OFDM Universal Filtered OFDM
UL Uplink
UMTS Universal Mobile Telecommunications System
URC Ultra-Reliable Communications
URLLC Ultra-Reliable and Low Latency Communications
UU User to User
V2V Vehicle to vehicle communications
V2X Vehicular communications
WLAN Wireless Local Area Networks and related technologies (IEEE 802.xx domain)
XR Extended Reality

The following description is for exemplary purposes and does not intent to limit in any way the applicability of the methods and apparatuses described herein to other wireless technologies and/or to wireless technology using different principles, when applicable. The term network in this disclosure may refer to one or more gNBs which in turn may be associated with one or more Transmission/Reception Points (TRPs) or any other node in the radio access network (RAN).

As used herein, the term MR-DC (Multi-Radio Dual Connectivity) indicates a dual connectivity between Evolved Universal Mobile Telecommunications System Terrestrial Radio Access (E-UTRA) and new radio (NR) nodes, or between two NR nodes.

In a radio resource control (RRC) connected state, the WTRU may measure at least on beam of a cell and the measurements results (e.g., power values) may be averaged to derive the cell quality. In doing so, the WTRU may be configured to consider a subset of the detected beams. Filtering may occur at two different levels: at the physical layer to derive beam quality and at the RRC level to derive cell quality from multiple beams. Cell quality from beam measurements may be derived in the same way for the serving cell(s) and for the non-serving cell(s). Measurement reports may contain the measurement results for a number (e.g., “X”) best beams if the WTRU is configured to do so by the gNB.

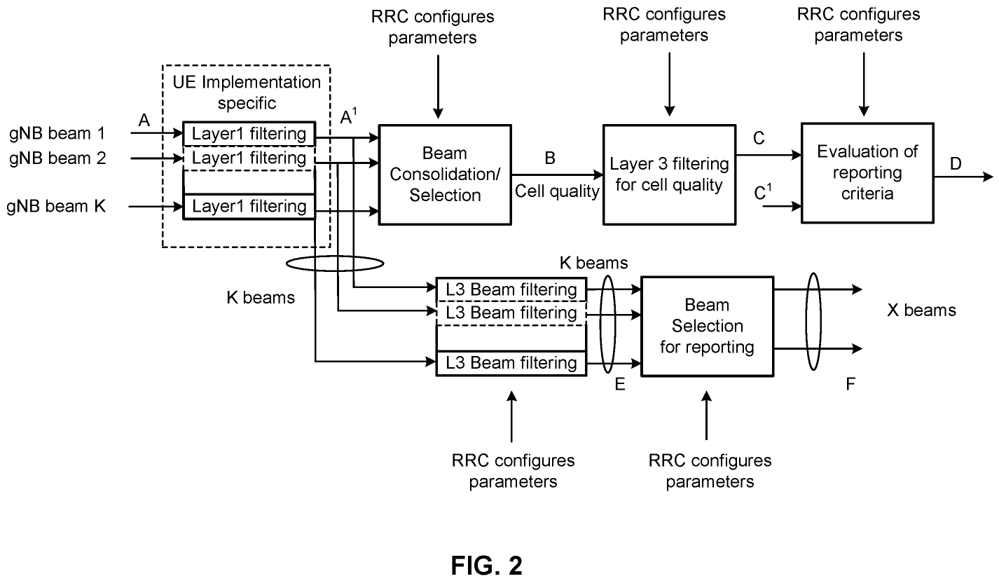

FIG. 2 illustrates a high level measurement model. As depicted in FIG. 2, K beams correspond to measurements on single side band (SSB) or channel state information—reference signal (CSI-RS) resources which may be configured for layer 3 (L3) mobility by a gNB and detected by a WTRU at layer 1 (L1).

In FIG. 2, A represents the measurement (beam specific samples) internal to the physical layer. Layer 1 filtering 202 is internal layer 1 filtering of the inputs measured at point A. How the measurements are actually executed in the physical layer by an implementation (inputs A and Layer 1 filtering) may be implementation dependent. A¹ represents the measurements (e.g., beam specific measurements) reported by layer 1 to layer 3 after layer 1 filtering.

Beam Consolidation/Selection 204 represents beam specific measurements that are consolidated to derive cell quality. The behavior of the Beam consolidation/selection 204 may be standardized and the configuration of this module may be provided by RRC signaling. Any appropriate reporting period may be implemented at B. For example, a reporting period at B may equal one measurement period at A¹.

B represents a measurement (e.g., cell quality) derived from beam-specific measurements reported to layer 3 after beam consolidation/selection 204. Layer 3 filtering for cell quality 206 represents filtering performed on the measurements provided at point B. The behavior of the Layer 3 filters 206 may standardized and the configuration of the layer 3 filters may be provided by RRC signaling. Any appropriate filtering reporting period may be implemented at C. For example, a filtering reporting period at C may equal one measurement period at B.

C represents a measurement after processing in the layer 3 filter 206. The reporting rate may be identical to the reporting rate at point B. This measurement may be used as input for one or more evaluation of reporting criteria.

Evaluation of reporting criteria 208 checks whether actual measurement reporting is necessary at point D. The evaluation may be based on more than one flow of measurements at reference point C, e.g., to compare between different measurements. This is illustrated by input C and C¹. The WTRU may evaluate the reporting criteria at least every time a new measurement result is reported at point C, C¹. The reporting criteria may be standardized and the configuration may be provided by RRC signaling (e.g., WTRU measurements).

D represents measurement report information (e.g., message) sent on a radio interface.

L3 Beam filtering 210 represents filtering performed on the measurements (e.g., beam specific measurements) provided at point A¹. The behavior of the beam filters may be standardized and the configuration of the beam filters may be provided by RRC signaling. Any appropriate filtering reporting period may be implemented at E. For example, a filtering reporting period at E may equal one measurement period at A¹.

E represents measurements (e.g., beam-specific measurements) after processing in the beam filter 208. The reporting rate may be identical to the reporting rate at point A1. This measurement may be used as input for selecting the X measurements to be reported.

Beam Selection for beam reporting 212 may select the X measurements from the measurements provided at point E. The behavior of beam selection 212 may be standardized and the configuration of this module may be provided by RRC signaling. F represents beam measurement information included in measurement report (sent) on the radio interface.

Layer 1 filtering 202 may introduce a level of measurement averaging. How and when a WTRU performs the measurements of Layer 1 filtering 202 may be implementation specific. For example, measurements performed at Layer 1 filtering 202 may be performed such that the output, B, of beam consolidation/selection 204, may meet performance requirements of applicable standards (e.g., TS 38.133). In an example embodiment, Layer 3 filtering 206 for cell quality and related parameters used do not introduce any delay in the sample availability between B and C. Measurement at point C, C¹ is the input used in event evaluation 208. In an example embodiment, L3 Beam filtering 210 and related parameters used do not introduce any delay in the sample availability between E and F.

Measurement reports may include the measurement identity of the associated measurement configuration that triggered the reporting. Cell and beam measurement quantities to be included in measurement reports may be configured by the network. The number of non-serving cells to be reported may be limited through configuration by the network. Cells may be configured by the network to not be used in event evaluation and reporting. These cells may be referred to as cells on a black list. Cells may be configured by the network to be used in event evaluation and reporting. These cells may be referred to as cells on a whitelist. Beam measurements to be included in measurement reports may be configured by the network (beam identifier only, measurement result and beam identifier, no beam reporting, or the like, etc.).

SSB based intra-frequency measurement may be a measurement wherein the center frequency of the SSB of the serving cell and the center frequency of the SSB of the neighbor cell are the same, and the subcarrier spacing of the two SSBs is also the same.

SSB based inter-frequency measurement may be a measurement wherein the center frequency of the SSB of the serving cell and the center frequency of the SSB of the neighbor cell are different, or the subcarrier spacing of the two SSBs is different.

For SSB based measurements, one measurement object may correspond to one SSB and the WTRU may consider different SSBs as different cells.

CSI-RS based intra-frequency measurement may be a measurement wherein: (1) the SCS of CSI-RS resources on the neighbor cell configured for measurement is the same as the SCS of CSI-RS resources on the serving cell indicated for measurement; (2) for SCS =60kHz, the CP type of CSI-RS resources on the neighbor cell configured for measurement is the same as the CP type of CSI-RS resources on the serving cell indicated for measurement; and (3) the center frequency of CSI-RS resources on the neighbor cell configured for measurement is the same as the center frequency of CSI-RS resource on the serving cell indicated for measurement.

CSI-RS based inter-frequency measurement may be a measurement if it is not a CSI-RS based intra-frequency measurement.

Whether a measurement is non-gap-assisted or gap-assisted may depend on the capability of the WTRU, the active BWP of the WTRU, and the current operating frequency. For SSB based inter-frequency measurement, if the measurement gap requirement information may be reported by the WTRU, a measurement gap configuration may be provided according to the information. Otherwise, a measurement gap configuration may be provided in the following cases: (1) if the WTRU only supports per-WTRU measurement gaps and (2) if the WTRU supports per-FR measurement gaps and any of the serving cells are in the same frequency range of the measurement object.

For SSB based intra-frequency measurement, if the measurement gap requirement information is reported by the WTRU, a measurement gap configuration may be provided according to the information. Otherwise, a measurement gap configuration may be provided other than the initial BWP, if any of the WTRU configured BWPs do not contain the frequency domain resources of the SSB associated to the initial DL BWP.

The measurement reporting configuration nay be either event triggered or periodical. If it is periodical, the WTRU may send the measurement report every reporting interval (which may range between 120 ms and 30 min).

For event triggered measurements, the WTRU may send the measurement report when the conditions associated with the event are fulfilled. WTRU may continue to measure the serving cell and neighbors report quality and validate it with the threshold or offset defined in report configuration. The report quality/the trigger for an event may be a reference signal received power (RSRP), reference signal received quality (RSRQ), or a signal to interference and noise ratio (SINR).

The following Intra-RAT measurement events are used herein for NR: (1) Event A1; (2) Event A2; (3) Event A3; (4) Event A4; (5) Event A5; and (6) Event A6.

Event A1 may be triggered when the report quality for the serving cell becomes better than a threshold. Event A1 may be used to cancel an ongoing handover procedure. This may be the case if a WTRU moves towards a cell edge and triggers a mobility procedure, but subsequently moves back into good coverage before the mobility procedure has completed.

Event A2 may be triggered when the report quality of the serving cell becomes worse than a threshold. Since it does not involve any neighbor cell measurements, Event A2 may be used to trigger a blind mobility procedure, or the network may configure the WTRU for neighbor cell measurements when it receives a measurement report that is triggered due to Event A2 in order to save WTRU battery (e.g., not perform neighbor cell measurement when the serving cell quality is good enough).

Event A3 may be triggered when the report quality of the neighboring cell becomes better than the report quality of the SpCell by an offset. The offset may be positive or negative. Event A3 may be used for a handover procedure. Note that an SpCell(special cell) is the primary serving cell of either the Master Cell Group (MCG), i.e. the PCell, or Secondary Cell Group (SCG), i.e. the PSCell. Thus, in DC operation, the Secondary Node (SN) may configure an A3 event for SN triggered PSCell change.

Event A4 may be triggered when the report quality of the neighboring cell becomes better than a threshold. Event A4, may be used for handover procedures which do not depend upon the coverage of the serving cell (e.g. load balancing, where the WTRU is handed over to a good neighbor cell even if the serving cell conditions are excellent).

Event A5 may be triggered when the report quality of the SpCell becomes worse than a first threshold (threshold1) and the report quality of the neighboring cell becomes better than the a second threshold (threshold2). Like Event A3, Event A5 may be used for handover, but unlike Event A3, it provides a handover triggering mechanism based upon absolute measurements of the serving and neighbor cell, while Event A3 uses relative comparison. As such, it may be suitable for time critical handover when the serving cell becomes weak and it is necessary to change towards another cell which may not satisfy the criteria for an Event A3 handover.

Event A6 may be triggered when the report quality of the neighboring cell becomes better than the report quality of the secondary cell (SCell) by an offset. Event A6 may be used for SCell addition/releasing.

Event B1 and Event B2 may be defined for Inter-RAT measurement in NR. Event B1 may be triggered when the report quality of the Inter RAT neighboring cell becomes better than a threshold. Event B1 is equivalent to Event A4, but for the case of the inter-RAT handover. Event B2 may be triggered when the report quality of the PCell becomes worse than threshold1 and the report quality of the inter RAT neighboring cell becomes better than threshold2. Event B1 is equivalent to A5, except for the case of inter-RAT handover.

The WTRU's measurement configuration may contain an s-measure configuration (s-MeasureConfig), which specifies a threshold for NR SpCell RSRP measurements controlling when the WTRU is to perform measurements on non-serving cells. The value may be a threshold corresponding to the PCell's or PSCell's RSRP. If the measured PCell RSRP is above the s-measure threshold, the WTRU may not perform measurements on non-serving cells, which may improve WTRU power consumption (e.g., WTRU does not perform unnecessary measurements if it has very good radio conditions towards the serving cells).

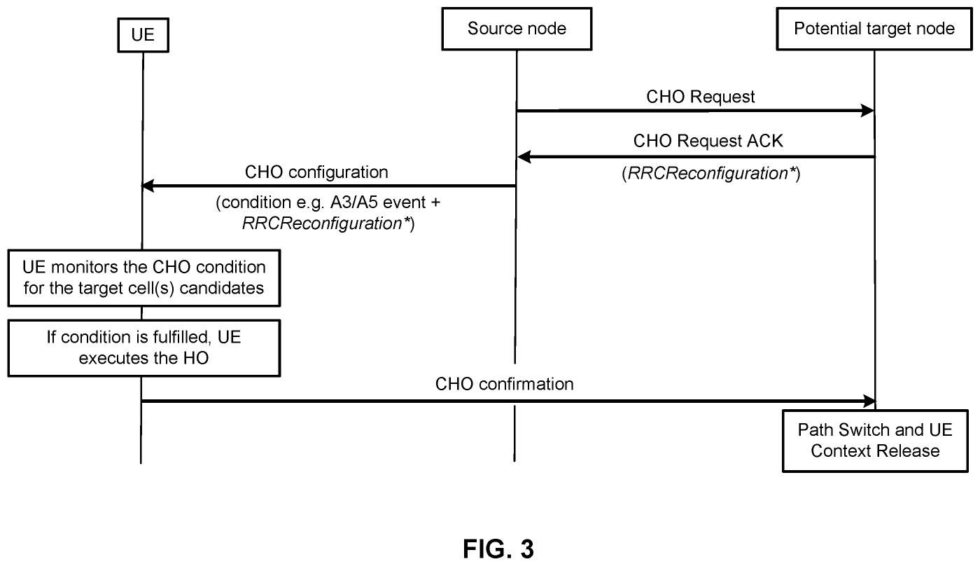

FIG. 3 is a diagram illustrating an exemplary conditional handover configuration and execution. A conditional handover (CHO) and a conditional PSCell (primary cell of a secondary cell group) Addition/Change (CPA/CPC, or collectively referred to as CPAC), may reduce the likelihood of radio link failures (RLFs) and handover failures (HOFs). As shown in FIG. 3, a source node in the network may send a request to a potential target node to prepare a CHO of the WTRU to the target node. The target node may respond and send a reconfiguration command to be sent by the source node to the WTRU representing the WTRU's configuration on the target node. The source node then may send the CHO command to the WTRU which may include the condition and the target node configuration. When the condition is met at the WTRU, the WTRU may initiate the HO and send the CHO confirmation to the target node when the reconfiguration is complete

LTE/NR handover may be triggered by measurement reports, even though there is nothing preventing the network from sending a handover a (HO) command to the WTRU even without receiving a measurement report. For example, a WTRU may be configured with an A3 event that triggers a measurement report to be sent when the radio signal level/quality (RSRP, RSRQ, etc.) of a neighbor cell becomes better than the Primary serving cell (PCell) or also the Primary Secondary serving Cell (PSCell), in the case of Dual Connectivity (DC). The WTRU may monitor the serving and neighbor cells and may send a measurement report when the conditions get fulfilled. When such a report is received, the network (current serving node/cell) may prepare the HO command (e.g., an RRC Reconfiguration message, with a reconfigurationWithSync) and send it to the WTRU, which the WTRU may execute immediately resulting in the WTRU connecting to the target cell.

CHO may differ from the above in at least two aspects: (1) multiple handover targets may be prepared (as compared to only one target) and (2) the WTRU may not immediately execute the CHO. Instead, the WTRU may be configured with triggering conditions, such as a set of radio conditions, and the WTRU may execute the handover towards one of the targets when/if the triggering conditions are fulfilled.

The CHO command may be sent when the radio conditions towards the current serving cells are still favorable, thereby reducing the two points of failure in legacy handover, i.e., risk failing to send the measurement report (e.g. if the link quality to the current serving cell falls below acceptable levels when the measurement reports are triggered in normal handover) and the failure to receive the handover command (e.g. if the link quality to the current serving cell falls below acceptable levels after the WTRU has sent the measurement report, but before it has received the HO command).

Triggering conditions for a CHO may be based on the radio quality of the serving cells and neighboring cells to trigger measurement reports. For example, the WTRU may be configured with a CHO that has A3-like triggering conditions and associated HO commands (302). The WTRU may monitor the current and serving cells (304) and when the A3 triggering conditions are fulfilled, it will, instead of sending a measurement report, executes the associated HO command (306) and switches its connection towards the target cell (308).

Another benefit of CHO is in helping prevent unnecessary re-establishments in case of a radio link failure. For example, assume the WTRU is configured with multiple CHO targets and the WTRU experiences an RLF before the triggering conditions with any of the targets are fulfilled. Legacy operation would have resulted in RRC re-establishment procedure that would have incurred considerable interruption time for the bearers of the WTRU. However, in the case of CHO, if the WTRU, after detecting an RLF, ends up a cell for which it has a CHO associated with (e.g., the target cell is already prepared for it), the WTRU may execute the HO command associated with this target cell directly, instead of continuing with the full re-establishment procedure.

CPC and CPA are extensions of CHO, but in DC scenarios. A WTRU may be configured with triggering conditions for a PSCell change or addition, and when the triggering conditions are fulfilled, it may execute the associated PSCell change or PSCell add commands.

A WTRU in MR-DC having one or more split bearers may be configured with a split bearer threshold. The split bearer threshold may be used to determine the data transmission to each leg of the split bearer by the WTRU. Specifically, the packet data convergence protocol (PDCP) layer may route data to either the MCG or both MCG and SCG based on the split bearer threshold. If the amount of data available for a bearer exceeds the split bearer threshold, the WTRU may route data for that bearer either to the MCG or SCG. Otherwise, the WTRU may send data for that bearer to the MCG only.

Procedures for MR-DC may use LTE Dual Connectivity concepts as a baseline. This means that the WTRU may be configured with two separate schedulers (MN and SN), where one scheduler or cell group may be considered to be the master node or the RRC anchor, and the other scheduler may provide bandwidth extension, on the same or different RAT.

With use cases and applications such as extended reality (XR) that utilize larger bandwidths, multiconnectivity (the ability for the WTRU to be scheduled by multiple SNs) may be implemented. This ability at the WTRU also increases the flexibility of the network to configure the WTRU with multiple collocated or non-collocated nodes/gNBs to boost the WTRU's bandwidth at specific times.

However, there may be some aspects to consider regarding extending MR-DC in NR to support multiconnectivity. Many of the procedures in NR MR-DC (e.g. MCGFailureRecovery, S-RLF reporting, UL data splitting) were specifically for two cell groups only (MCG and SCG), and were not designed with the multiconnectivity scenario in mind.

Simply repeating the MR-DC procedures (e.g. RLF determination) on multiple cell groups may not scale well at the WTRU as it may result in excessive power consumption at the WTRU, especially when some cell groups at the WTRU may be related from the network perspective.

A WTRU may be configured with a set of related cell groups. Such relation may be obtained in dedicated RRC signaling. Specifically, the WTRU may be configured with multiple, potentially active, SCGs (SCG1, SCG2, . . . , SCGx), and may be configured with one or more sets of SCGs (e.g. set 1=SCG1+SCG4+SCG5, set2=SCG2+SCG3, etc.).

Such grouping may be realized, for example, by configuring the WTRU with a set of PSCell identifiers (IDs) belonging to the same group. Alternatively, the network may broadcast (e.g., in master information block/system information block (MIB/SIB) a group ID and the WTRU may associate the cells with the same group ID to be associated with the same group. The grouping (set) of cell groups may be utilized for a number of the solutions described herein.

In one family of embodiments, a WTRU may perform RLM/RLF procedure across multiple/all of the cell groups of the set. The WTRU may perform RLM/RLF procedure applicable to all of SCG1, SCG4, SCG5, which may be part of set 1.

In one embodiment, the WTRU may perform RLM/RLF procedure on a one cell group or SCG, or a subset of such, within the set. For example, the WTRU may be configured with a primary SCG of a set of SCGs, and perform RLM/RLF only on the primary SCG. Alternatively, the WTRU may be configured with certain criteria for selecting the SCG on which RLF is performed. For example, the WTRU may perform RLM/RLF on the cell group(s) corresponding to any or a combination of: (1) the cell group(s) with the minimum/maximum radio resource management (RRM) measurements (e.g. min/max RSRP), possibly determined over a time period; (2) the cell group(s) where the measured RRM measurements being above/below a threshold, possibly determined over a time period; (3) the cell group(s) on which the WTRU has been scheduled the most often, or has been provided the largest amount of UL/DL resources; and/or (4) the cell group(s) with the best/worst beam measurements.

The WTRU may perform a combined RLM/RLF procedure on multiple cell groups by applying a TDM of reference signal evaluation over the multiple cell groups. Specifically, a WTRU may perform in synchronization/out of synchronization (IS/OOS) evaluation over a first SCG for a first period of time, then perform IS/OOS evaluation over a second SCG for the next period of time, and so on across all SCGs of a set. The WTRU may perform the RLF procedure by the regular counting of IS/OOS generated sequentially across each of the SCGs. The WTRU further may be configured with a sequencing of the SCGs in the set, and the period of time spent on each SCG for IS/OOS evaluation.

The WTRU may initiate RLM/RLF on a SCG as a result of an RLM/RLF event occurring one another SCG (possibly the primary SCG or selected SCG described in a previous solution). In general terms, the RLM/RLF on one cell group (e.g., SCG) may influence/affect the RLM/RLF on another cell group (e.g., SCG). For example, the WTRU may be initially configured to perform RLM/RLF on a single SCG (possibly of a set) and may initiate RLM/RLF on all SCGs (possibly of a set) following an RLF event on the single SCG. For example, a WTRU may initiate RLM/RLF on one or more or all SCGs (possibly of a set) upon any of the following: (1) RLF is triggered on an SCG; (2) the number of consecutive OOS indications on an SCG exceeds a threshold; (3) timer is started on an SCG (e.g., a T310 radio link failure timer); and/or (4) the value of T310 exceeds a threshold on an SCG.

In the above embodiment, the WTRU similarly may be configured with rules for stopping RLM/RLF which was started (e.g., as described above) based on other RLM/RLF events associated with another SCG.

A WTRU may report the SCG on which a sidelink radio link failure (S-RLF) was detected. In addition, the WTRU may report the RLF status (e.g. value/status of timers) on other SCGs which may not have triggered RLF at the time of reporting. The WTRU may report multiple SCGs if S-RLF was detected on multiple SCGs at the same time.

A WTRU may delay reporting of a S-RLF in order to determine whether a S-RLF may occur (shortly thereafter) on other SCGs. The WTRU then may be able to report a S-RLF on multiple SCGs, rather than transmitting multiple separate reports. For example, the WTRU may delay S-RLF reporting after triggering a S-RLF using any or a combination of conditions, such as: (1) an amount of time, wherein the WTRU may determine all SCGs which trigger RLF during that time to determine what to report; and/or (2) another SCG close to RLF triggering. For example, the WTRU may delay S-RLF reporting if at the time of triggering S-RLF on one SCG, another SCG has a timer (e.g., a T310 timer) running. The WTRU may wait for expiry of the timer before reporting S-RLF (possibly on both SCGs). Alternatively, if the timer is stopped, and possibly no other timers are running for any SCGs, the WTRU may report S-RLF on all SCGs that triggered it up to the time of reporting. For example, the WTRU may delay S-RLF reporting if at the time of triggering S-RLF on one SCG, another SCG has a timer running. The WTRU may wait for expiry of the timer before reporting S-RLF (possibly on both SCGs). Alternatively, if the timer is stopped, and possibly no other timers are running for any SCGs, the WTRU may report S-RLF on all SCGs that triggered it up to the time of reporting.

A WTRU may detect and report a master cell group (MCG) failure when configured with multiple SCGs. The WTRU may select the best SCG (e.g., based on criteria specified herein) to transmit MCG Failure. Alternatively, the WTRU may select the SCG on a first frequency band (FR1), if available. Alternatively, the WTRU may be configured to duplicate MCG failure procedure on a subset or all of the configured or activated SCGs. The WTRU further may be configured with rules as to the number of SCGs on which to duplicate MCG Failure report.

The configuration may be based on the priority of the highest priority bearer configured on the MCG which failed. For example, the WTRU may be configured with a number of SCGs on which to transmit MCG failure based on the priority of the highest priority bearer configured at the WTRU (or having data available) when MCG failure occurred.

The configuration may be based on the frequency band of the SCG(s) on which to report MCG Failure. For example, if the WTRU selects an SCG on a second frequency band (FR2), the WTRU may duplicate the MCGFailure message, possibly on all SCGs configured with FR2.

In another embodiment, the WTRU may transmit MCGFailure on a first SCG. If the WTRU does not receive a response from the network for a period of time, the WTRU may re-transmit MCGFailure on a second SCG. The WTRU may attempt such sequential transmissions of MCGFailure on a configured number of SCGs, or on all SCGs configured for the signal radio band (SRB) (e.g., if configured with a split SRB). The WTRU may attempt such sequential transmissions of MCGFailure on all SCGs for which an SRB (e.g., split SRB1 or SRB3) is configured.

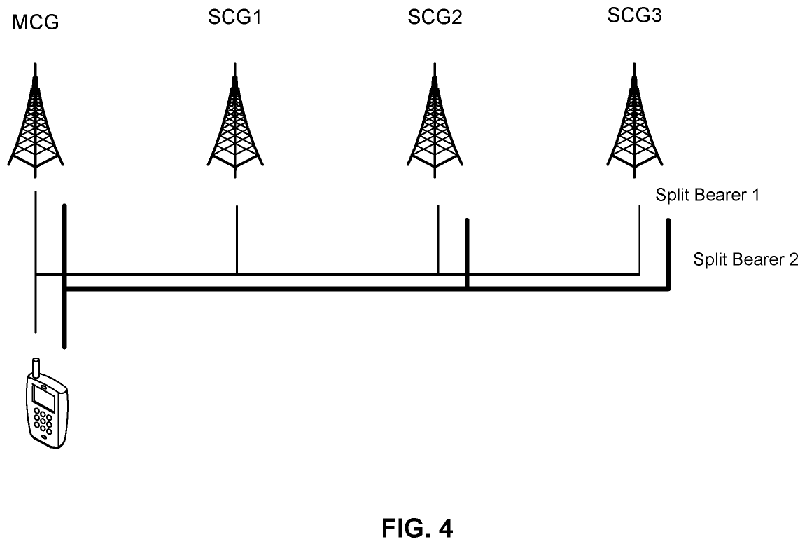

FIG. 4 is a diagram illustrating an exemplary split-bear transmission. WTRU procedures for routing UL data for a split bearer in the presence of multiple SCGs, such as SCG1, SCG2, SCG3 depicted in FIG. 4, configured at the WTRU are discussed below. Example embodiments apply to the selection of an SCG (split bearer leg) to which a WTRU may transmit uplink data when the WTRU is configured with a split bearer with multiple legs. For example, a WTRU may be configured with multiple active SCGs (e.g., SCG1, SCG2, SCG3 depicted in FIG. 4) and with a split bearer having a leg to each of these active SCGs. For example, as depicted in FIG. 4, Split Bearer 1 has legs connected to the master cell group (MCG), SCG1, SCG2, and SCG3. And Split Bearer 2 has legs connected to MCG, SCG2, and SCG3. Such an WTRU may be configured with rules to determine when the WTRU may transmit to any of these legs, which legs may be used for transmission, and the amount of UL data to be is routed to each of these legs.

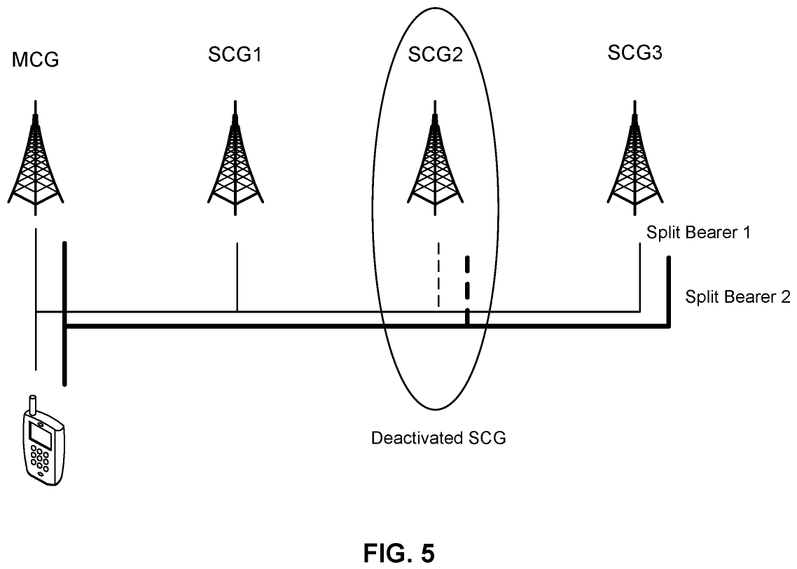

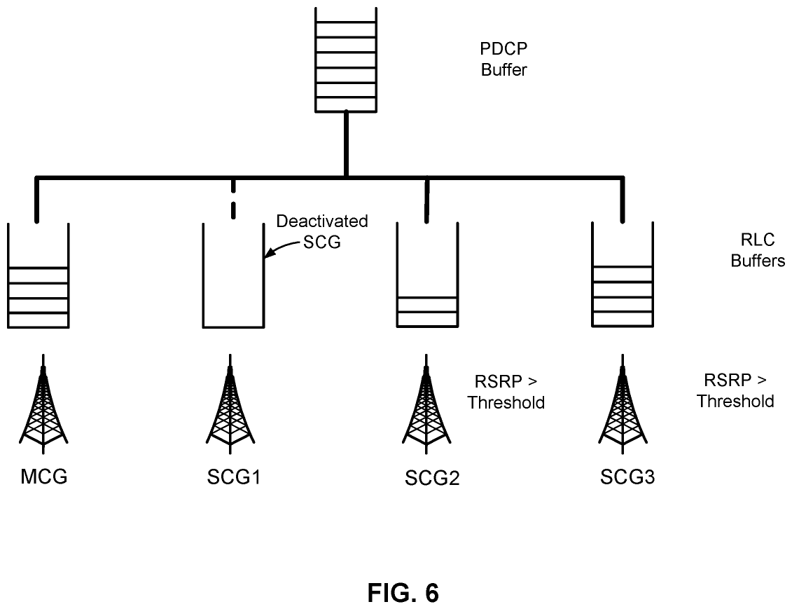

Embodiments also may apply to the activation and/or deactivation of a SCG. FIG. 5 is a diagram illustrating an exemplary deactivated secondary cell group SCG2.A SCG may be deactivated, for example, to save power consumed by the WTRU. The SCG configuration on the WTRU, however, may be maintained in order to achieve a fast transition into dual connectivity. A network may activate and/or deactivate the SCG for a WTRU using, for example, RRC signaling. For a deactivated SCG, in an example embodiment, the WTRU may not monitor the physical downlink control channel (PDCCH), and may perform reduced operations on user to user (UU) communications (e.g., reduced RRM measurements, RLM may be configured by the network, timing advance may not be maintained). A WTRU may trigger SCG activation (e.g., if the WTRU is configured with a deactivated SCG), for example, by transmitting a RRC message (UEAssistanceInformation). The WTRU may trigger transmission of this message when data arrives at a SCG bearer while the SCG is deactivated. A WTRU may trigger activation of a deactivated SCG based upon a comparison of a channel condition value associated with the deactivated SCG and a channel condition threshold associated with a bearer. Other WTRU-based mechanisms for triggering activation may include any appropriate combination of the following.
Triggering a random access channel (RACH) or other physical layer transmission (sounding reference signal (SRS), channel quality indicator (CQI), tec.) to the PSCell of the SCG.
Triggering a transmission to the SCG on dedicated UL resources.
Sending a MAC CE to the MCG to indicate the SCG should be activated.
A RSRP value of a deactivated SCG being greater than or equal to a RSRP threshold of a bearer.

Rules and procedures described herein may be utilized to determine whether a specific SCG may be activated upon the reception of UL data. For example, a WTRU may activate a SCG if the WTRU selects a leg for UL routing, and the SCG is currently deactivated. A WTRU may activate a deactivated SCG by performing an UL transmission on the SCG, such as: (1) a random access channel (RACH) procedure (e.g., if the WTRU is not timing aligned on that SCG) and/or (2) triggering an scheduling request (SR) (if the WTRU is timing aligned on that SCG).

FIG. 5 is a diagram illustrating an exemplary deactivated secondary cell group (SCG). A WTRU may be configured with separate conditions for activation of a SCG/leg selection. As depicted in FIG. 5, SCG2 has been deactivated for both split bearer 1 and split bearer 2. As explained in more detail herein, a WTRU may select a leg for routing data for a bearer if the corresponding SCG is activated from the WTRU perspective, and/or activate a deactivated SCG for selection.

As described herein, rules and procedures for determining the SCG(s) to use assume that the split bearer is configured with the MCG as the primary path (for example, if the amount of data is below a threshold, the WTRU may transmit to the primary path which is the MCG). The configuration, however, is not limited thereto. Without loss of generality, these same rules and procedures may be applied when the primary path is the SCG.

In one example embodiment, a WTRU may trigger activation of one or more SCGs using an uplink transmission. WTRU-based activation procedure may indicate (implicitly or explicitly) more than one SCGs to be activated. The WTRU may indicate, in the UL transmission, the SCG(s) it wishes to activate. For example, the WTRU may be configured with specific SR resources, where each SR resource indicates activation of one or more SCG. For example, the WTRU may include, in the RACH procedure (e.g. via a small data transmission), the SCGs to be activated. For example, the WTRU may decide to activate a single SCG, or all related SCGs (as described herein) together, and may be configured with separate SR indices for either of these options (or may indicate which option is desired based on information included in the RACH procedure.

WTRU-based activation procedure may last for a finite period of time. The WTRU may be configured with a time period over which WTRU-based activation procedure is applicable. For example, the WTRU may assume, following WTRU-based activation, that the SCG(s) activated stay in activated state for the configured time period. Following expiry of the time period, and/or an explicit network (NW) signaled deactivation, the WTRU may assume the SCG(s) move back to deactivated state.

FIG. 6 is a diagram illustrating exemplary deactivated of SCG2. A WTRU may be configured with a condition on when to deactivate a previously activated SCG. This may apply to an SCG which was activated by the WTRU. This also may apply to a SCG activated by the network. Potentially, the NW may indicate (e.g., as part of the activation) whether deactivation by condition is allowed for the SCG.

For example, the WTRU may deactivate an SCG upon a condition associated with a measurement report. For example, the WTRU may assume an SCG to be deactivated following an RRM measurement report, CQI measurement report, beam failure or beam management report, possibly associated with the SCG itself, or another SCG. For example the reported RSRP measurements of the SCG may be above/below a threshold, possibly following a number of consecutive measurement reports. In another example, the reported RSRP measurements of another SCG and/or the MCG may be above/below a threshold, possibly following a number of consecutive measurement reports. In another example, beam failure may be detected/reported on one or more cells of the SCG.

A WTRU may be configured with a single split bearer threshold, possibly for a specific bearer, to determine whether it can transmit on one or more SCGs. Specifically, when the amount of data available at a split bearer exceeds a threshold, as depicted in FIG. 6, buffer 302, the WTRU may transmit data to one or more SCGs. Furthermore, a WTRU may be configured with one or more rules to determine which SCG(s) can be used for routing data of a split bearer via that SCG, and/or the amount of data which can be routed via that SCG. For example the WTRU may transmit data, possibly for a specific bearer, to any of one or more SCGs associated with the split bearer when the amount of data pending for a specific split bearer (302) is above a configured split bearer threshold, provided a condition is satisfied.

In another example, the WTRU may select the specific SCG from a set of SCGs associated with a split bearer based on a condition. In another example, the WTRU may activate a specific deactivated SCG associated with a split bearer based on a condition. In another example, the amount or percentage of data which can be transmitted, possibly for a split bearer, to a specific SCG may be determined from a condition. In another example, the amount of time the WTRU can use a specific SCG for routing data, possibly for a split bearer, may be determined from a condition. In another example, the amount of time the WTRU can assume a specific SCG is activated (following WTRU-based activation), may be determined from a condition. In another example, the number of SCGs which can be used by the WTRU, possibly for transmission of data from a split bearer, may be determined from a condition. Such conditions may encompass one or combination of several of the following factors:

One factor may be a network configuration, possibly for a specific bearer. For example, a WTRU may be configured to allow routing of data for a specific UL bearer to a specific SCG. Such configuration may be in the form of a set of allowable SCGs for a specific bearer, or in the form of a set of allowable bearers for a specific SCG. Such configuration can also be in the form of a restricted set of SCGs (e.g., a set of SCGs for which a particular split bearer cannot be used to transmit UL data to, possibly when certain other conditions are met). For example, the WTRU may be configured whether a specific split bearer can trigger activation of a deactivated SCG or not, possibly when the UL split bearer threshold is exceeded. Specifically, if other conditions described herein are satisfied, a WTRU may activate an SCG if the split bearer is configured to allow SCG activation and data arrives at the SCG. For example, the WTRU may be configured with a maximum number of SCGs which may be selected for transmission/routing of data for a specific split bearer, and may transmit data on a number of SCGs up to that maximum. In addition, a WTRU may have a maximum number of SCGs it may transmit on (based on WTRU capability, for example) and may determine the maximum number of SCGs based on this capability, as well as the maximum indicated by the particular bearer configuration. For example, the WTRU may be configured with rules (e.g. based on RSRP) of whether the WTRU should enable transmission to a single SCG, or more SCGs (possibly to a maximum number of SCGs). This is depicted in FIG. 6, wherein SCG2 and SCG3 are selected for UL transmission based on their respective values of reference signal received power (RSRP) values being above respective thresholds.

Another condition may be the SCG activation state. For example, the WTRU can select an SCG for routing of data from a split bearer only from the set of activated SCGs at the time. For example, the WTRU can prioritize routing of data to the set of activated SCGs. For example, such prioritization may be performed in case the number of SCGs required/used based on other rules exceeds the WTRU capability, and the WTRU needs to select a subset of SCGs.

Another condition may be the relationship between SCGs, as described herein (e.g., set of related cell groups). For example, a WTRU can be configured with a set of related cell groups. When the amount of data is larger than the split bearer threshold, the WTRU may select any SCGs for transmission of data from the bearer as long as the SCGs selected are part of a related set. The WTRU may receive the set of related cell groups by RRC configuration. Alternatively, the WTRU may receive a parameter from each cell group transmission (e.g., an index) and use the parameter to derive the related cell groups (e.g., all cell groups transmitting the same index).

Another condition may be the measured quality of the cell group in terms of any of the following measurements: (1) RRM measurements of the PSCell and/or SCells (e.g. RSRP, etc.); (2) beam measurements of the PSCell and/or SCells; and/or (3) CSI measurements of the PSCell and/or SCells. For example, the WTRU may select the set of SCGs whose measurements exceed a threshold. For example, RSRP measurements may be defined for a SCG. RSRP for an SCG may be defined as any appropriate combination of: (1) the RSRP measurements for the PSCell of the SCG, possibly measured over a configured time period and/or (2) the average RSRP measurements of the PSCell and all configured SCells of the SCG, possibly measured over a configured time period.

Another condition may be historical data related to a specific SCG, such as a number of events which may have occurred on a specific SCG in a configured period of time. Such event may include, but not be limited to: (1) beam failure events, or related events; (2) RLF events, or related events (e.g. IS/OOS); HARQ related events (e.g. ACK/NACK detection), or the like, or any appropriate combination thereof. For example, the WTRU may maintain a running average of the number of beam failures on an SCG, and select the SCG(s) with the lowest number of SCGs. For example, the relative amount of data routed by the WTRU to each SCG, possibly associated with a specific bearer, may depend on the measurements. Specifically, the WTRU can route a percentage of data to an SCG based on the ratio of quality of that SCG compared to other SCGs.

Another condition may be frequency range (e.g., FR1 vs FR2). For example, the WTRU may select or prioritize the SCG configured on a specific frequency band (e.g., FR1). In another example, the WTRU may, in selecting an SCG, first select those SCGs configured on a specific frequency band (e.g., FR1).

Another condition may be the total amount of data available from all bearers, or all split bearers, at the WTRU. For example, the WTRU may start using at least one SCG when the amount of data available at the WTRU exceeds a UL split bearer. The number of SCGs which may be used in the case may be determined by the total amount of data (across all bearers, or across all split bearers) available at the WTRU. The rules may be defined based on the solution described for multiple thresholds applied to the total data (e.g., 1 SN for a first range of data amount, 2 SNs for a second range of data amount, etc.).

Another condition may be the amount of data routed to one or more SCG by the WTRU. For example, the WTRU may activate a deactivated SCG (if one is present) if the amount of data being routed to all activated SCGs (possibly taking into account a subset of bearers or all bearers) exceeds a configured threshold.

Another condition may be whether the primary path of the bearer is a MCG or a SCG. For example, if the primary path of the bearer is a MCG, the WTRU may select from one of the allowable/activated SCGs when the split bearer threshold is configured. If the primary path is a SCG, the WTRU may consider the MCG as an allowable/activated path. The WTRU may further route data to the MCG first, or prioritize the MCG is this case (where it would not do such prioritization to an SCG if the primary path was the MCG).

Another condition may be the capability of the WTRU. For example, the WTRU may determine a maximum number of SCGs it can use, for a bearer, or for all bearers, at least based on its WTRU capability. For example, the WTRU may use, for a specific UL split bearer, a few number of SCGs than configured for the bearer, because using a large number would require activation of a number of SCGs which exceeds the WTRU capabilities.

In one embodiment, a WTRU may determine the number of configured SCGs to be activated based on the total amount of data on all split bearers as well as the amount of data available for specific split bearers that allow activation. The WTRU may then determine the SCGs to be used for a specific split bearer based on the activation state of the SCG and the maximum number of SCGs configured for that bearer. For example, the

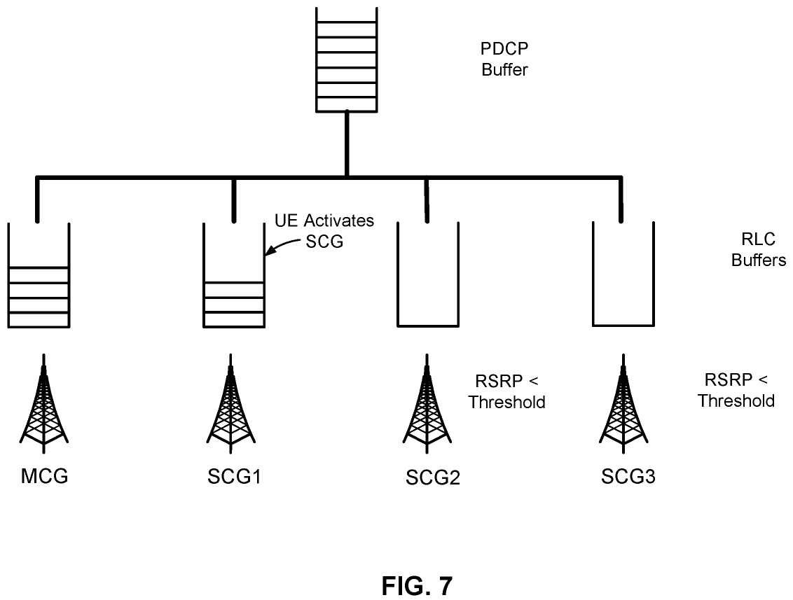

WTRU may be configured with one or more split bearers, each configured to use a subset of the configured SCGs. The WTRU may be configured per split bearer with a maximum number of SCGs which may be used for transmission of data for the split bearer, and whether the split bearer can trigger SCG activation on its own. The WTRU may first determine a number of SCGs which should be activated based on the total amount of data available for transmission on all split bearers. For example, the WTRU may be configured with a first number of SCGs which may be activated when the total amount of data available for transmission is within a first range, a second number of SCGs which may be activated when the total amount of data available for transmission is in a second range and so on. The WTRU may activate one or more SCGs if the number of currently activated SCGs is lower than the number of allowable SCGs for the currently available amount of data. The WTRU may route each split bearer among one of the activated SCGs if the amount of data pending for transmission at a split bearer above a split bearer threshold configured for the bearer. Specifically, if the amount of data pending for transmission at the split bearer is below the split bearer threshold, the WTRU may route all data for the split bearer to the MCG. If the amount of data pending for transmission at the split bearer is above the split bearer threshold, the WTRU may route data to the MCG and any of the activated SCGs configured for the bearer, up to a maximum configured for the bearer. The WTRU may, if the bearer is configured to allow activation of an SCG, further activate one or more SCGs if the number of activated SCGs at the WTRU is below the maximum configured for the split bearer. This is depicted in FIG. 7, wherein SCG1 is activated. The WTRU may select any SCGs for routing of data. Alternatively, the WTRU may prioritize (e.g., select first) SCGs in a specific frequency band (e.g., FR1).

In another embodiment, a WTRU may be configured with one or more SCGs allowable for a split bearer, and be configured with a maximum number of allowable number of SCGs for a specific split bearer. The WTRU may further be configured with a threshold RSRP for which WTRU autonomous activation is required. The WTRU may determine, when the data rate is above a threshold, whether to allow transmission to one (or more) activated SCGs, or whether to allow the WTRU to activate additional SCGs for the bearer, depending on a channel condition, such as, for example, the measured RSRP of the activated SCG. For example, the WTRU may use the MCG and one or more SCGs (which were activated by the network, for example) as long as the one or more SCGs are above a threshold RSRP. If one/all of the SCGs have measurements below an RSRP threshold (possibly configured for the bearer), and the bearer allows WTRU activation of an SCG, the WTRU may activate one or more SCG using mechanisms described herein. In an example embodiment, the WTRU may activate a first SCG only, as long as the first SCG has RSRP above a threshold. The WTRU may activate multiple SCG (possibly up to a maximum) for example if all of the SCGs have RSRP below a threshold. The WTRU may further deactivate any SCGs that were activated by the WTRU (e.g., by indication to the network, or implicitly following transmission of a measurement report, for example), if the RSRP condition above is such that the WTRU does not require the maximum number or SCGs activated for that bearer.

In another embodiment, a WTRU may be configured with one or more SCGs allowable for a split bearer. If the amount of data available for transmission at the split bearer is above the UL split bearer threshold, the WTRU may transmit data to both MCG and SCG(s) configured for that specific split bearer.

In another embodiment, the WTRU may be configured with a maximum number of split bearer legs which may be for routing data to a particular SCG at a given time. For example, SCG1 may be configured to be used for routing data from a maximum of x split bearers, SCG2 can be configured to be used for routing data from a maximum of y split bearers, and so on. Without loss of generality, x and y may be configured equally cross all SCGs. When multiple split bearers have data which exceeds the UL split bearer threshold, the WTRU may select the SCG(s) used for transmission of each split bearer based on priority mechanism. For example, the WTRU may select all SCGs configured for transmission of the highest priority split bearer, then select all SCGs configured for transmission of the next highest priority split bearer, and so on. When the number of bearers actively transmitting to an SCG reaches the maximum, the next highest priority split bearer may be limited/restricted to the configured SCGs which have not reached the maximum number of active (e.g., data exceeding the split bearer threshold) split bearers.

In another family of embodiments (which may be used in conjunction with the previous family), the WTRU may be configured with multiple UL split thresholds for routing associated with a split bearer. The WTRU may determine the number of SCGs, and/or the SCGs to use, for routing of data from a split bearer based on the multiple thresholds.

In one example, a WTRU may be configured with a set of thresholds defining a range of data amounts for a split bearer, and the corresponding number of SNs. Specifically, the WTRU may use 1 SCG when the amount of data for the bearer exceeds the split bearer threshold but is between a first threshold. The WTRU may use 2 SCGs if the amount of data for the bearer exceeds the first threshold but is below the second threshold. And so on. The set of thresholds may be configured per bearer, or a single set of thresholds can apply to all bearers.

A WTRU may be configured per SCG with a separate UL split bearer threshold applicable to that SCG. If the amount of data available at the WTRU, possibly associated with a specific bearer, exceeds the SCG dependent threshold, the WTRU may use the SCG for routing of data of any particular split bearer. The WTRU may then use any of the rules described herein for selecting the specific SCG for a particular split bearer when the WTRU multiple SCGs may be used. For example, a specific bearer may be configured with a maximum number of SCGs it can use. The WTRU may select any SCGs, or the best SCGs, that are considered usable based on their respective threshold, where selection may use quality as a metric.

A first threshold may be used for determining whether the WTRU may route to a first SCG, a second threshold to both first and second SCGs, etc., and the specific SCGs to use with each threshold may be further defined (e.g., in order of configuration at the WTRU, or by associating the threshold with an SCG index). For example, if the amount of data at a bearer is above a first threshold, the WTRU may use the MCG and the SCG associated with the first threshold. If the amount of data at a bearer is above a second threshold, the WTRU may use the MCG, the SCG associated with the first threshold, and the SCG associated with the second threshold. The WTRU may further be configured on a per bearer basis as to which SCG is associated with the first threshold, second threshold, etc.

In any of the above examples, the WTRU may be configured with a set of thresholds specific to different factors, such as: (1) frequency band (a set of thresholds for FR1 and another for FR2), (2) split bearer type (e.g. MCG terminated, SCG terminated, number of legs, etc.), (3) total number of SCGs configured, (4) priority of the bearer, or the like, or any appropriate combination thereof.

The WTRU may determine the UL split bearer threshold based on the configured and/or activated SCG. For example, the WTRU may determine the threshold of data availability for allowing transmission and/or activation of one or more SCG based on number of configured and/or activated SCGs.

The WTRU may determine the UL split bearer threshold based on the number of activated SCGs. For example, the WTRU may be configured, per bearer, with a value of UL split bearer thresholds for each number of activated SCG s (threshold1 when 1 SCG is activated, threshold2 when 2 SCGs are activated, and so on). The WTRU may be configured with a multiplication factor to be applied to a first value of UL split bearer threshold based on the number of activated SCGs. In either case, the WTRU first may determine the UL split bearer threshold to be applied for a given number of activated SCGs. When the amount of data available at a bearer exceeds the determined threshold, the WTRU may transmit data to MCG and one or more SCGs. Otherwise, the WTRU may transmit to the MCG only.

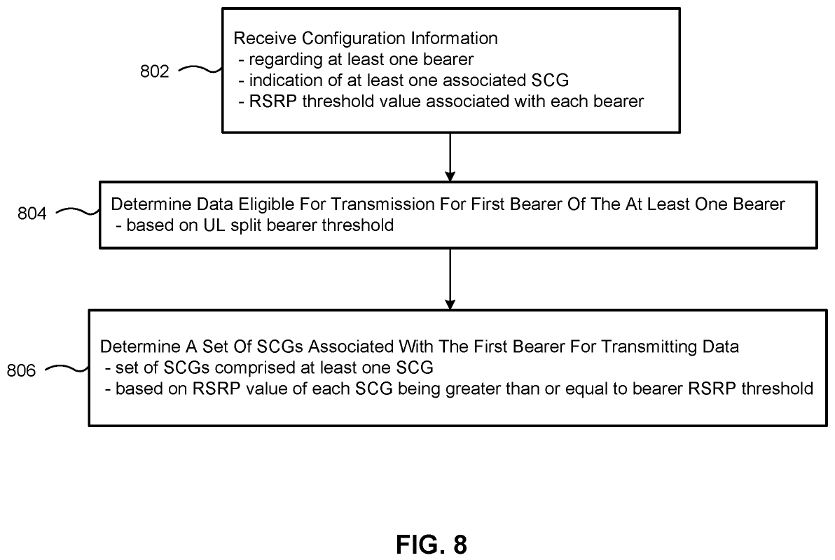

FIG. 8 is a flow diagram of an example process for operating with split bearers. At step 802, a WTRU may receive configuration information. The configuration information may comprise information regarding at least one bearer or multiple bearers. For each bearer, the configuration information may comprise an indication of at least one SCG that is associated therewith. For example, if the configuration comprises information regarding a single bearer, the information may comprise an indication of at least one SCG associated with the single bearer. If the configuration information comprises information regarding multiple bearers, for each of the multiple bearers, the information may comprise an indication of a respective associated SCG or SCGs. The configuration information also may comprise a RSRP threshold associated with each bearer.

At step 804, the WTRU may determine that data for a bearer is eligible for transmission based on a UL split bearer threshold. For example, each bearer of multiple bearers may have a respective UL split bearer threshold associated therewith. If data for a bearer (e.g., a first bearer) of the multiple bearers is available for transmission, and the data is equal to or exceeds the UL split bearer threshold for the first bearer, the WTRU may determine that the data for the first bearer is eligible for transmission.

At step 806, the WTRU may determine a set of SCGs associated with a bearer for transmitting the data based on RSRP values and thresholds. For example, each bearer of multiple bearers may have a respective channel condition (e.g., RSRP threshold value) associated therewith. Also, SCGs associated with a bearer (e.g., a first bearer) may have respective associated channel conditions (e.g., RSRP values). The WTRU may determine that each SCG associated with the first bearer having a RSRP value equal to or greater than the first bearer RSRP threshold, may be in the set of SCGs associated with the first bearer for transmitting the data. A set of SCG my comprise a single SCG or multiple SCGs.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods, apparatuses, and articles of manufacture, within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

Although foregoing embodiments may be discussed, for simplicity, with regard to specific terminology and structure, (e.g., radio frequency (RF), microwave, centimeter wave, micrometer wave, infrared (IR), ultraviolet (UV), visible light, etc.), the embodiments discussed, however, are not limited to thereto, and may be applied to other systems that use other forms of electromagnetic waves or non-electromagnetic waves such as acoustic waves, for example.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis, or the like, or any appropriate combination thereof. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to Figures. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media, which are differentiated from signals, include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of methods, apparatuses, articles of manufacture, and systems provided above are possible without departing from the scope of the invention. In view of the wide variety of embodiments that can be applied, it should be understood that the illustrated embodiments are examples only, and should not be taken as limiting the scope of the following claims. For instance, embodiments provided herein include handheld devices, which may include or be utilized with any appropriate voltage source, such as a battery or the like, providing any appropriate voltage.

Moreover, in embodiments provided herein, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable storage medium including magnetic disks, optical disks, and any other volatile (e.g., Random Access Memory (RAM) or non-volatile (e.g., Read-Only Memory (ROM)) mass storage system readable by the CPU. The computer readable storage medium may include cooperating or interconnected computer readable media, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable storage medium. The computer-readable instructions may be executed by a processor of a mobile unit, a network element, and/or any other computing device.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In example embodiments, several portions of the subject matter described herein may be implemented via Application Specific Integrated Circuits (ASICs), Field Programmable Gate Arrays (FPGAs), digital signal processors (DSPs), and/or other integrated formats. Those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. Those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

What is claimed is:

1-22. (canceled)

23. A wireless transmit/receive unit (WTRU) comprising memory and a processor, the WTRU configured to:
receive configuration information regarding at least one bearer, the configuration information comprising:
an indication of at least one communication path associated with each bearer of the at least one bearer; and
a channel condition threshold associated with each bearer of the at least one bearer;
determine that first data associated with a first bearer of the at least one bearer is eligible for transmission; and
determine a set of communication paths associated with the first bearer for transmitting the first data, wherein the set of communication paths comprises one or more communication paths of the at least one communication path associated with the first bearer, and wherein the determination of the set of communication paths for transmitting the first data is based upon a comparison of a channel condition value of each communication path of the set of communication paths with the channel condition threshold associated with the first bearer.

24. The WTRU of claim 23, wherein each communication path of the at least one communication path is associated with a secondary cell group (SCG) or associated with a relay node.

25. The WTRU of claim 23, wherein:
the channel condition threshold associated with the first bearer comprises a reference signal received power (RSRP) threshold associated with the first bearer;
the channel condition value of each communication path of the set of communication paths comprises a RSRP value of each communication path of the set of communication paths; and
the comparison of the channel condition value of each communication path of the set of communication paths with the channel condition threshold associated with the first bearer comprises the RSRP value of each communication path of the set of communication paths being greater than or equal to the RSRP threshold associated with the first bearer.

26. The WTRU of claim 23, wherein the determination that the first data associated with the first bearer of the at least one bearer is eligible for transmission, is based upon an uplink (UL) split bearer threshold associated with the first bearer.

27. The WTRU of claim 23, wherein the configuration information comprises a maximum number of communication paths that can be associated with each bearer of the at least one bearer.

28. The WTRU of claim 23, wherein the set of communication paths associated with the first bearer for transmitting the first data comprises a number of communication paths less than or equal to a maximum number of communication paths that can be associated with the first bearer.

29. The WTRU of claim 23, wherein the first data is in the form of a protocol data unit (PDU).

30. The WTRU of claim 23, further configured to transmit the first data via the set of communication paths associated with the first bearer.

31. The WTRU of claim 23, wherein all communication paths of the set of communications paths are configured on a specific frequency band.

32. A method performed by a wireless transmit/receive unit (WTRU), the method comprising:
receiving configuration information regarding at least one bearer, the configuration information comprising:
an indication of at least one communication path associated with each bearer of the at least one bearer;
a channel condition threshold associated with each bearer of the at least one bearer;
determining that first data associated with a first bearer of the at least one bearer is eligible for transmission; and
determining a set of communication paths associated with the first bearer for transmitting the first data, wherein the set of communication paths comprises one or more communication paths of the at least one communication path associated with the first bearer, and wherein determining the set of communication paths for transmitting the first data comprises comparing a channel condition value of each communication path of the set of communication paths with the channel condition threshold associated with the first bearer.

33. The method of claim 32, wherein each communication path of the at least one communication path is associated with a secondary cell group (SCG) or associated with a relay node.

34. The method of claim 32, wherein:
the channel condition threshold associated with first bearer comprises a reference signal received power (RSRP) threshold associated with the first bearer;
the channel condition value of each communication path of the set of communication paths comprises a RSRP value of each communication path of the set of communication paths; and
comparing the channel condition value of each communication path of the set of communication paths with the channel condition threshold associated with the first bearer comprises determining that the RSRP value of each communication path of the set of communication paths is greater than or equal to the RSRP threshold associated with the first bearer.

35. The method of claim 32, wherein determining that the first data associated with the first bearer of the at least one bearer is eligible for transmission, is based upon an uplink (UL) split bearer threshold associated with the first bearer.

36. The method of claim 32, wherein the configuration information comprises a maximum number of communication paths that can be associated with each bearer of the at least one bearer.

37. The method of claim 32, wherein the set of communication paths associated with the first bearer for transmitting the first data comprises a number of communication paths less than or equal to a maximum number of communication paths that can be associated with the first bearer.

38. The method of claim 32, wherein the first data is in the form of a protocol data unit (PDU).

39. The method of claim 32, further comprising transmitting the first data via the set of communication paths associated with the first bearer.

40. The method of claim 32, wherein all communication paths of the set of communication paths are configured on a specific frequency band.
